(19) United States
(12) Patent Application Publication
(10) Pub. No.: US 2006/0110568 A1
(43) Pub. Date: May 25, 2006

(54) Multi-layers optical data storage disk masters

(75) Inventor: Jathan D. Edwards, Afton, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 10/996,590

(22) Filed: Nov. 23, 2004

(51) Int. Cl. B32B 3/02

(52) U.S. Cl. 428/64.4

(57) ABSTRACT

Mastering techniques are described that can improve the quality of a master used in data storage disk manufacturing. In one embodiment, the techniques include depositing a multi-layer structure adjacent a substrate layer of the master, the multi-layer structure including a first layer, a second layer formed over the first layer, and a third layer formed over the second layer, wherein the first layer comprises a substantially reflective base layer. The techniques also include defining a portable conformable mask (PCM) with the third layer, and defining a feature of the master in the second layer through the PCM of the third layer. In some embodiments, a nanometer scale topographical feature may be defined in the first layer of the master via an etching process or a thin film deposition.

### TECHNICAL FIELD

The invention relates to manufacturing techniques for creation of optical data storage disks.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable), CD-ROM (CD-read only memory), DVD (digital versatile disk or digital video disk), DVD-RAM (DVD-random access memory), and various other types of writable or rewriteable media, such as magneto-optical (MO) disks, phase-change optical disks, and others. Some newer formats for optical data storage disks are progressing toward smaller disk sizes and increased data storage density. Many new formats boast improved track pitches and increased storage density using blue-wavelength lasers for data readout and/or data recording. A wide variety of optical data storage disk standards have been developed and other standards will continue to emerge.

Optical data storage disks are typically produced by first making a data storage disk master that has a surface pattern that represents encoded data on the master surface. The surface pattern, for instance, may be a collection of grooves or other features that define master pits and master lands, e.g., typically arranged in either a spiral or concentric manner. The master is typically not suitable as a mass replication surface with the master features defined within an etched photoresist layer formed over a master substrate.

After creating a suitable master, that master can be used to make a stamper, which is less fragile than the master. The stamper is typically formed of electroplated metal or a hard plastic material, and has a surface pattern that is the inverse of the surface pattern encoded on the master. An injection mold can use the stamper to facilitate the creation of large quantities of replica disks. Also, rolling bead processes can use the stampers to fabricate replica disks. In any case, each replica disk may contain the data and tracking information that was originally encoded on the master surface. The replica disks can be coated with a reflective layer and/or a phase-change layer, and are often sealed with an additional protective layer. Other media formats, such as magnetic disk formats, may also use similar mastering-stamping techniques, e.g., to create media having small surface topology features, which may correspond to magnetic domains.

In some cases, the surface pattern encoded on the data storage disk master represents an inverse of the desired replica disk pattern. In those cases, the master is typically used to create a first-generation stamper, which is in turn used to create a second-generation stamper. The second-generation stamper, then, can be used to create replica disks that contain an inverse of the surface pattern encoded on the master. Creating multiple generations of stampers can also allow for improved replica disk productivity from a single data storage disk master.

The mastering process is one of the most critical stages of the data storage disk manufacturing process. In particular, the mastering process defines the surface pattern to be created in replica disks. The intrinsic resolution and precision of the master disk pattern is ultimately transferred to the replica disks. Likewise, the master will pass on any variations or irregularities to stampers and replica disks, and therefore, the creation of a high quality master is important to the creation of high quality replica disks. For this reason, it is highly desirable to improve mastering techniques.

The mastering process commonly uses a photolithographic process to define the master surface pattern. To facilitate the mastering process, an optically flat master substrate is coated with a layer of photoresist. A tightly focused laser beam passes over the photoresist-coated substrate to expose grooves or other latent features in the photoresist, which may be categorized as a direct-write photolithographic technique. The focused beam may also be modulated or wobbled to define information such as encoded data, tracking servos, or the like, within the features of the master disk. After exposing the photoresist, a developer solution removes either the exposed or unexposed photoresist, depending on whether a positive or negative photoresist material is used. In this development step, the latent exposure pattern is manifest as a topographical master pattern.

### SUMMARY

In general, the invention is directed to mastering techniques that can improve the quality of a master used in data storage disk manufacturing. In particular, the techniques described herein can improve resolution of the features created on the master. In some embodiments, the techniques provide feature dimension control to generate nanometer scale features on the master, and therefore, on an optical data storage disk. In other embodiments, the techniques can be adapted to create nano-scale topographical features of a magnetic data storage disk on the master.

In the simplest case, the techniques include depositing a multi-layer structure, comprising a first layer, a second layer formed over the first layer, and a third layer formed over the second layer, adjacent a master substrate layer. The mastering techniques further include the steps of master recording openings in the third layer of the structure and etching at least one of the sublayers through the mastered openings. In other cases, additional layers may be included in the master. Moreover, subsequent steps of thin film coating and/or etch processes may be useful for defining either positive or negative type nanometer scale topographical features on the master.

The first layer of the multi-layer structure may comprise a substantially reflective base layer. The second layer may comprise a thickness that substantially eliminates reflection of the light out of the multi-layer stack by means of optical interference, e.g., a quarter of a wavelength of the incident light. Hence, the second layer may be described as an optical interference layer. The third layer comprises a recordable material sensitive to a master recording wavelength.

Master recording uses a focused beam of light to photo-etch openings in the third layer to define a portable conformable mask (PCM) for the second layer. A subsequent etching process defines features in the second layer by etching through the contact mask openings in the third layer. The resultant topographical pattern may then be transferred to a first stamper element by standard or multi-generational means to produce multiple replica disks which are representative of either the topography of the etched master disk or the inverse topography of the etched master disk.

The techniques described herein may also be used to create masters for the replication of non-optical media, such as magnetic media, that includes topographical surface variations on a nano-scale. For example, the PCM may allow definition of microscopic surface variations in the form of bumps, pits, ridges, grooves, or the like, in the first layer. Patterned media may be developed from the master to increase storage densities and improve quality and reliability of magnetic media. The surface of a patterned magnetic medium may be coated with one or more magnetic layers. The surface variations may then be magnetically encoded, e.g., for the purpose of information storage. Each of the nanometer scale topographical features may be sized on the order of a single magnetic domain.

In one embodiment, the invention is directed to a method of creating a data storage disk master. The method comprises depositing a multi-layer structure adjacent a substrate layer of the master, the multi-layer structure including a first layer, a second layer formed over the first layer, and a third layer formed over the second layer. The first layer comprises a substantially reflective base layer. The method further comprises defining a contact mask with the third layer, and defining a feature of the master in the second layer through the contact mask of the third layer.

In another embodiment, the invention is directed to a data storage disk master comprising a substrate layer and a multi-layer structure deposited adjacent the substrate layer. The multi-layer structure includes a first layer that comprises a substantially reflective base layer, a second layer formed over the first layer, and a third layer formed over the second layer. The third layer defines a contact mask and the second layer defines a feature of the master defined through the contact mask of the third layer.

In another embodiment, the invention is directed to a method of creating a data storage disk master to include small topographical features. The method comprises depositing a multi-layer structure adjacent a substrate layer of the master, the multi-layer structure including a first layer, a second layer formed over the first layer, and a third layer formed over the second layer. The method further comprises defining a contact mask with the third layer and removing a region of the second layer through the contact mask to physically expose a region of the first layer. Additionally, the method includes defining a nanometer scale topographical feature at the physically exposed region of the first layer.

The nanometer scale topographical feature may define a height between approximately 5 and 200 nanometers, and a width between approximately 20 and 300 nanometers. The described techniques can be used to create masters to form non-optical data storage disks having topographical features on this nano-scale. Uniform pits and/or bumps having heights less than 50 nanometers and widths less than 150 nanometers may be particularly difficult or impossible to create with accuracy, without the benefit of the teaching of this disclosure.

The invention may be capable of providing one or more advantages. For example, the substantially reflective base layer coupled with an optical interference thickness of the second layer helps ensure that approximately all of the energy from the light is deposited into the third layer to provide efficient and accurate photo-etching. Therefore, the described techniques can improve resolution of the features created on the data storage disk master by increasing resolution of the PCM. The PCM may comprise a resolution capable of defining lateral dimensions for nanometer scale topographical features of the master.

In addition, the techniques described herein can be used to improve sidewall geometries of master disk topographical features, and therefore of topographical features on replica disks. For example, photo-etching the third layer can create a third layer sidewall with a third sidewall angle relative to a horizontal plane. The second layer may then be etched through the photo-etched region of the third layer. Etching the second layer creates a second layer sidewall with a second sidewall angle based on the third sidewall angle. If an etch process of selectivity greater than one is used, the second sidewall angle can be made greater than the third sidewall angle. In this way, the PCM may create features on the master with substantially vertical sidewalls, which can then be used to create similar replica disks.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an illumination system that may be used to photo-etch regions of a data storage disk master, in accordance with embodiments of the invention.

FIG. 2 is a block diagram illustrating an etching system that may be used to physically remove regions of a data storage disk master, in accordance with embodiments of the invention.

FIGS. 3A and 3B are schematic diagrams illustrating a mastering technique for a data storage disk master.

FIGS. 4A-4E are schematic diagrams illustrating another mastering technique for a data storage disk master.

FIG. 5 is a schematic diagram illustrating a portion of a data storage disk master that may be used to define nanometer scale topographical features.

FIGS. 6A and 6B are schematic diagrams illustrating a technique for defining nanometer scale topographical features on the master from FIG. 5.

FIGS. 7A and 7B are schematic diagrams illustrating another exemplary technique for defining nanometer scale topographical features on the master from FIG. 5.

FIG. 8 is a schematic diagram illustrating an exemplary data storage disk comprising nanometer scale topographical features.

FIG. 9 is a schematic diagram illustrating another exemplary data storage disk comprising nanometer scale topographical features.

FIG. 10 is a schematic diagram illustrating a trench or groove defined in a data storage disk master according to an embodiment of the invention.

### DETAILED DESCRIPTION

The invention is directed to mastering techniques that can improve the quality of a master used in data storage disk manufacturing. In the simplest case, the techniques include depositing a multi-layer structure, comprising a first layer, a second layer formed over the first layer, and a third layer formed over the second layer, adjacent a master substrate layer. The mastering techniques further include the steps of master recording openings in the third layer of the structure and etching at least one of the sublayers through the mastered openings.

The third layer comprises a recordable material sensitive to a master recording wavelength. Master recording uses a light, such as a focused laser spot, to photo-etch openings in the third layer to define a portable conformable mask (PCM) for the second layer. The second layer may comprise a thickness that substantially eliminates reflection of the light out of the multi-layer stack by means of optical interference, e.g., a quarter of a wavelength of the incident light. Hence, the second layer may be described as an optical interference layer. The first layer of the multi-layer structure may comprise a reflective base layer that substantially reflects the light transmitted through the second layer back to the third layer, where constructive interference increases the photo-etching efficiency.

The subsequent etching process defines features in the second layer by etching through the contact mask openings in the third layer. In regard to the etching process step, the second layer may be described as an etch layer. For etching processes proceeding to remove the full depth of the second layer, the base layer material may function as an etch-stop layer. In that case, the uniformity of the second layer thickness dictates the uniformity of the feature depth. Alternatively, for etching processes designed to remove only a portion of the second layer, the uniformity of the etching process dictates the uniformity of the feature depth.

The resultant topographical pattern may then be transferred to a first stamper element by standard or multi-generational means to produce multiple replica disks which are representative of either the topography of the etched master disk or the inverse topography of the etched master disk.

In some embodiments, a different thickness (e.g. different from a quarter of a wavelength of the incident light) may be desired for a final topographical feature depth of the master. In this case, a number of alternative multi-layer constructions may be used to define feature depths different from a quarter of a wavelength of the incident light after the etching processes. For a first example, the second layer may comprise two layers of different material such that the two layers together provide the optical interference function for the master recording step, but remain distinct during the subsequent etching processes due to differences in etch rates. In this way the thickness of the etchable portion of the dual second layer may comprise a thickness equal to a desired feature depth.

As a second example, another base layer and another etchable layer may be interposed between the substrate layer and the multi-layer structure described above. In this case, the two layers together comprise a thickness that provides the optical interference function for the master recording step and the additional etchable layer comprises a thickness approximately equal to a final feature depth desired for the master. In this way, the functions of optical interference and feature depth are separately assigned to two different layers in the master allowing for separate optimization.

In other embodiments, additional processing steps may be applied to create masters for the replication of non-optical media, such as magnetic media, that includes topographical surface variations on a nano-scale. The PCM may allow definition of microscopic surface variations in the form of bumps, pits, ridges, grooves, or the like, in the first layer. For example, a thin film coating may be applied to the first layer through the etched regions of the second layer. As another example, the first layer may be etched through the etched regions of the second layer. Patterned media may be developed from the master to increase storage densities and improve quality and reliability of magnetic media. The surface of a patterned magnetic medium may be coated with one or more magnetic layers. The surface variations may then be magnetically encoded, e.g., for the purpose of information storage. Each of the nanometer scale topographical features may be sized on the order of a single magnetic domain.

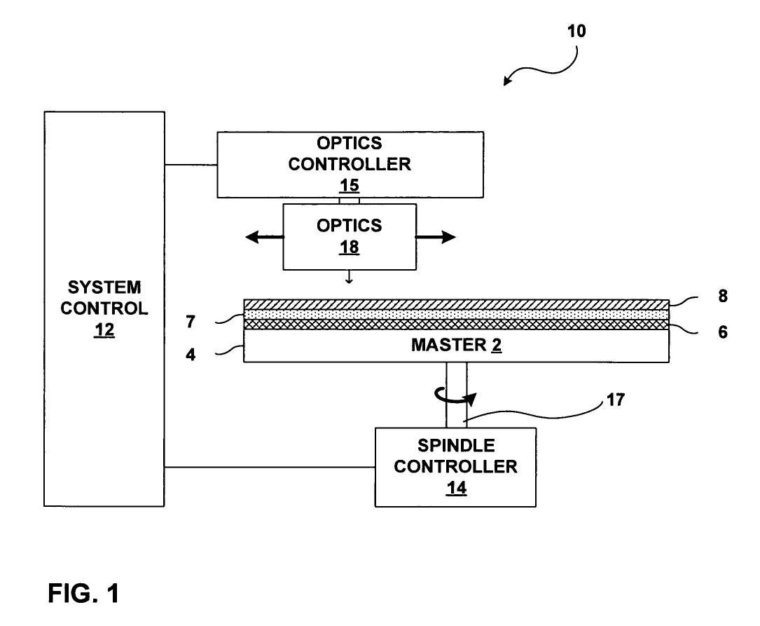

FIG. 1 is a block diagram illustrating an illumination system 10 that may be used to photo-etch regions of a master 2 in accordance with embodiments of the invention. In general, illumination system 10 includes a system control 12, such as a personal computer, workstation, or other computer system. System control 12, for example, may comprise one or more processors that execute software to provide user control over system 10. System control 12 provides commands to spindle controller 14 and optics controller 15 in response to user input. The commands sent from system control 12 to spindle controller 14 and optics controller 15 define the operation of system 10 during the master recording process.

Data storage disk master 2 (hereafter “master 2”) may comprise a disk-shaped glass substrate 4 with a multi-layer structure, as described herein, deposited adjacent substrate 4. Substrate 4 may comprise other substrate materials of suitable optical surface quality and may also comprise non-disk shapes. The multi-layer structure includes a first layer 6, a second layer 7 formed over first layer 6, and a third layer 8 formed over second layer 7. First layer 6 may comprise a substantially reflective base layer. In some cases, first layer 6 may act as an etch stop layer. Examples of substantially reflective materials that may also act as an etch stop include nickel (Ni), aluminum-chromium (Al/Cr), or other metals. Second layer 7 may comprise a dielectric material, e.g., silicon dioxide (SiO₂), or a photoresist material, e.g., Shipley 1805 positive resist material commercially available from the Shipley Corporation of Marlboro, Mass. In this embodiment, third layer 8 may comprise a metallic material, such as nickel (Ni), chrome (Cr), tellurium (Te), or titanium (Ti), or another photo-etchable material such as tellurium sub-oxide or an organic dye. In other embodiments, third layer 8 may comprise a phase-change material, such as GeSbTe (GST) or AgInSbTe (AIST).

Master 2 is carefully placed in system 10 on spindle 17. Optics 18 may provide light with energy capable of photo-etching a region of third layer 8, according to commands by system control 12, to define a portable conformable mask (PCM) for second layer 7. In the case where first layer 6 comprises a substantially reflective base layer, the base layer substantially reflects the light from optics 18 that is transmitted through second layer 7. Second layer 7 may be tuned to an optical interference thickness such that the reflection of the light out of the multi-layer stack is eliminated. Therefore, substantially all of the energy from the incident light is deposited in third layer 8, which increases efficiency and accuracy of the photo-etching process.

Spindle controller 14 causes spindle 17 to spin master disk 2, while optics controller 15 controls the positioning of optics 18 relative to master 2. Optics controller 15 also controls any on-off switching of light that is emitted from optics 18. As master 2 spins on spindle 17, optics controller 15 translates optics 18 to desired positions and causes optics 18 to emit light that photo-etches regions of third layer 8.

In embodiments where third layer 8 comprises a phase-change material, illumination system 10 may be used to define regions of master 2. Optics 18 may provide light that exposes third layer 8, according to commands by system control 12, to define the PCM for second layer 7. For the phase-change materials, the photo-etching step may include simple ablation of the material. Alternately, for the phase-change materials, the photo-etching step may include both the steps of exposure, to effect local amorphous/crystalline state, followed by the step of chemical etching, to selectively remove either the amorphous or crystalline regions. By either of these means, the light from optics 18 may induce changes in the material of third layer 8 that defines the contact mask.

In the case where second layer 7 comprises a photoresist material, optics 18 may provide light that photolithographically defines regions of second layer 7, according to commands by system control 12, to create the data storage disk master. Optics 18 may illuminate regions of second layer 7 through the PCM defined by third layer 8. A development step may then remove the photolithographically defined regions of second layer 7 to define features of master 2 in second layer 7. In the case where both third layer 8 and second layer 7 rely on separate exposure and development steps, second layer 7 may react with a wavelength of light substantially different than a wavelength of light with which third layer 8 reacts. In that way, illuminating third layer 8 does not substantially affect second layer 7 and illuminating second layer 7 does not substantially affect third layer 8.

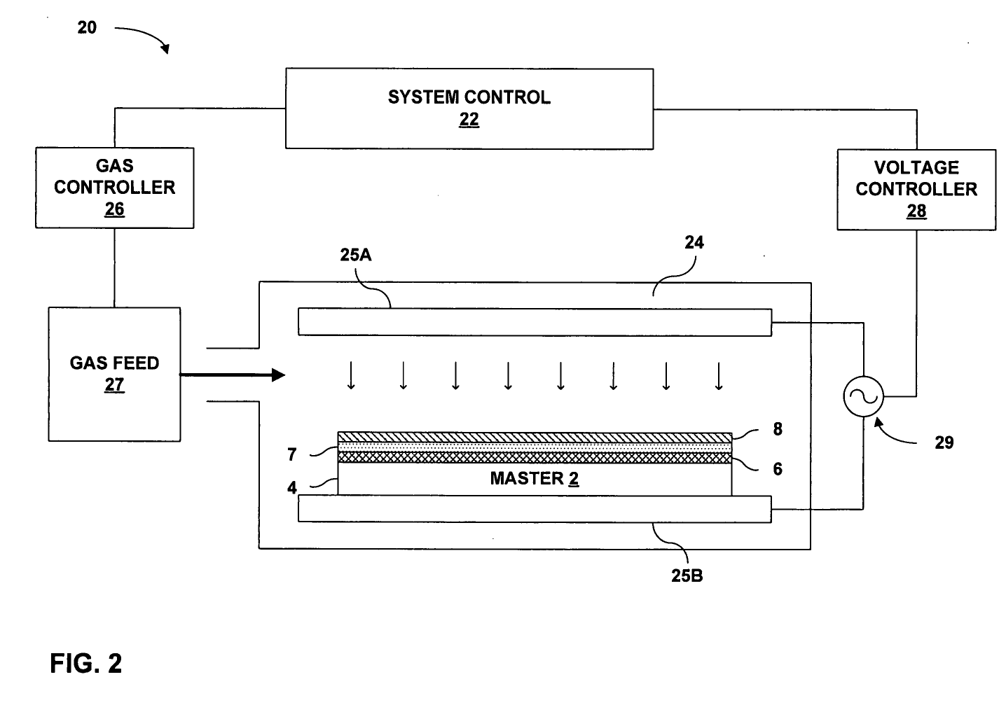

FIG. 2 is a block diagram illustrating an etching system 20 that may be used to physically remove regions of master 2 (FIG. 1), in accordance with embodiments of the invention. In the illustrated embodiment, etching system 20 comprises a plasma etching system capable of performing reactive ion etching (RIE). In other embodiments, any of a variety of etching systems may be used, including but not limited to sputtering systems, chemical etching systems, ion beam etching systems, and wet etching systems. In some cases, etching system 20 may also be used to develop the regions of master 2 photolithographically defined by illumination system 10. In the case of etching a photoresist layer, etching system 20 may comprise an oxygen plasma process commonly known as “ashing”.

In general, etching system 20 includes a system control 22, such as a personal computer, workstation, or other computer system. System control 22, for example, may comprise one or more processors that execute software to provide user control over system 20. System control 22 provides commands to gas controller 26 and voltage controller 28 in response to user input. The commands sent from system control 12 to gas controller 26 and voltage controller 28 define the operation of system 20 during the etch process.

System 20 also includes a vacuum chamber 24 with a top electrode 25A and a bottom electrode 25B driven by a power source 29. Voltage controller 28 controls power source 29 to generate a desired driving voltage level. Power source 29 provides top electrode 25A with a positive charge and bottom electrode 25B with a negative charge. A gas feed 27 introduces a gas into vacuum chamber 24 where the gas breaks down and forms a plasma. In this case, the plasma includes both etchant atoms and ions.

Master 2 is carefully placed in system 20 on bottom electrode 25B. Master 2 includes substrate 4 with the multi-layer structure, which includes first layer 6, second layer 7, and third layer 8, deposited adjacent substrate 4. In the illustrated embodiment, second layer 7 may comprise a dielectric material, such as SiO2. After third layer 8 has been photo-etched by optics 18 (FIG. 1) to define the PCM, master 2 may be placed in system 20 in order to etch regions of second layer 7 physically exposed through the contact mask. The current flowing from top electrode 25A to bottom electrode 25B causes positively-charged ions in the plasma to bombard master 2, which increases a reaction rate between the etchant atoms and second layer 7. RIE also increases anisotropy of the etch process to enhance sidewall angles of the features in second layer 7 and thereby improve resolution of master 2.

In the embodiment where second layer 7 comprises a photoresist material, another photolithographic illumination system, similar to system 10 may be used to develop regions of second layer 7. Alternately, in the embodiment where second layer 7 comprises a photoresist material, an oxygen plasma process, i.e., ashing, provides good selectivity and steep feature sidewalls in second layer 7.

In the case where third layer 8 comprises a phase-change material, system 20 may also be used to define the PCM for second layer 7 by developing regions of third layer 8 with photo-induced changes.

Conventional data storage disk mastering techniques use a single layer of photoresist coated onto a master substrate. The master is then recorded using a focused laser beam with a quasi-Gaussian intensity profile and a full-width-half-maximum (FWHM) spot size of approximately 0.57λ/N.A., where λ is the laser wavelength and N.A. is the numerical aperture of the recording objective. After development of the photoresist, the resulting features are a convolution of the focused Gaussian spot and the photoresist dissolution. Fundamental limitations to the conventional mastering techniques result from a dependence of the final feature geometry on the finite spot size limitation and sidewall shapes of the convolved Gaussian function.

As described in greater detail below, master 2 includes features that can improve the mastering process. In particular, the multi-layer structure including third layer 8, second layer 7, and a substantially reflective base layer 6 allows a master mask to be defined for second layer 7 such that fine feature resolution may be obtained on master 2. The method of forming the PCM, described herein, may also allow the formation of topographical features in master 2 that are of nanometer scale by using the tip of the focused laser beam to define openings in third layer 8.

The invention utilizes the substantially reflective base layer 6 and the optical interference structure of second layer 7 to deposit approximately 100% of the energy from the focused laser spot in third layer 8 to create a master with improved feature definition and increased storage density. For example, constructive interference in the tip of the focused spot enhances accuracy and efficiency of defining the PCM. In some cases, the light source may include a recording objective with an increased numerical aperture to improve feature resolution. Additionally, the light source may include near field optics or near field optical waveguides that create smaller than conventional spot sizes as a systematic solution for increasing mastering resolution.

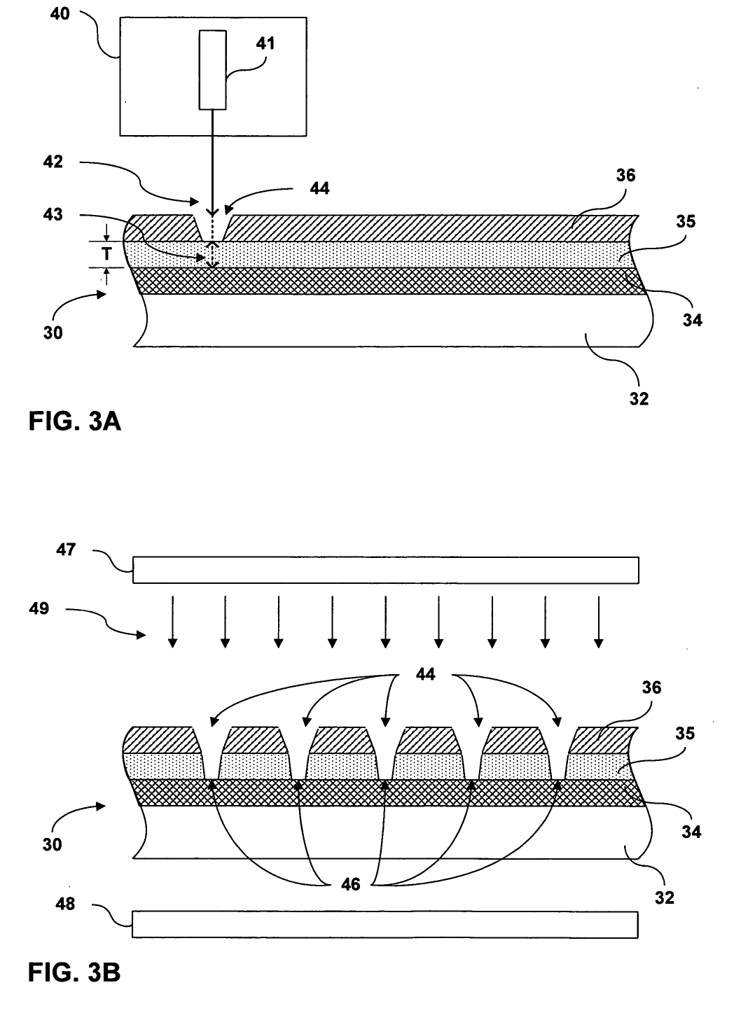

FIGS. 3A and 3B are schematic diagrams illustrating a mastering technique for a master 30. Master 30 includes a substrate layer 32 and a multi-layer structure comprising a first layer 34 formed over substrate layer 32, a second layer 35 formed over first layer 34, and a third layer 36 formed over second layer 35. In the illustrated embodiment, first layer 34 comprises a substantially reflective base layer designed to substantially reflect the light during the master recording process. First layer 34 also acts as an etch stop layer during the subsequent etching process step. Examples of substantially reflective materials that may act as an etch stop include nickel (Ni) and aluminum-chromium (Al/Cr).

Third layer 36 may comprise a metallic material, e.g., nickel (Ni), chrome (Cr), tellurium (Te), or titanium (Ti), or another material capable of being photo-etched such as tellurium sub-oxide or an organic dye to define a portable conformable mask (PCM) for second layer 35. In other embodiments, third layer 36 may comprise a phase-change material, such as GeSbTe (GST) or AgInSbTe (AIST), that can be either ablated or illuminated and developed in separate steps to define the PCM. Second layer 35 may comprise a dielectric material, e.g., silicon dioxide (SiO₂), that may be etched to define features of master 30. In other embodiments, second layer 35 may comprise a photoresist material that may be illuminated and developed in separate steps to define features of master 30. If both the second layer and the third layer comprise photoresist, the different photoresist layers may be sensitive to different wavelengths of light. In that case, different illuminating light can be used to define different photo-etching processes for the respective layers.

In general, the etching process for the third layer is a process for defining a PCM in that layer, e.g., typically a photo-ablative process or a photoresistive illumination and development process. The etching process for the second layer is a process for creating features in the second layer through the PCM of the first layer, e.g., typically a particle etching or non-photo process, such as RIE, but possibly a photoresistive illumination and development process in cases where different sensitivity resist materials are used.

Techniques according to the invention may include defining a PCM for second layer 35 by photo-etching a region of third layer 36. The techniques may also include defining a feature of master 30 by etching second layer 35 through the PCM defined by third layer 36. Master 30 may then be used to create stampers and replica disks for optical recording systems.

FIG. 3A illustrates a portion of master 30 being illuminated by optics 40, which may operate substantially similar to optics 18 in FIG. 1. Optics 40 includes a laser 41 that produces a light. Optics 40 then creates a precisely focused laser spot 42 from the light and illuminates third layer 36 of master 30 with focused laser spot 42. Illuminating third layer 36 with laser spot 42 provides energy to photo-etch a region 44 of third layer 36.

As third layer 36 is illuminated, a portion 43 of the light may be transmitted through second layer 35 to first layer 34. However, first layer 34 comprises a substantially reflective base layer that reflects a substantial portion 43 of the light back to region 44 of third layer 36. In some cases, second layer 35 comprises a thickness T that can be tuned as an optical interference structure, such that the light incident on the multi-layer structure constructively interferes in third layer 36 and little of the light reflects from the multi-layer structure. For example, thickness T may be approximately equal to a quarter of a wavelength of the incident light. Therefore, the multi-layer structure deposits approximately all of the light from focused laser spot 42 at region 44 of third layer 36. In this way, the multi-layer structure increases the efficiency and the accuracy of the photo-etching process, which improves a resolution of the features in the PCM.

As indicated above, thickness T associated with second layer 35 may be approximately equal to a quarter of a wavelength of the light or higher multiples of a quarter wavelength, i.e., 3λ/4, 5λ/4, etc. However, the optical λ/4 thickness also takes into account the refractive index of second layer 35 for a given light wavelength. In the case where second layer 35 comprises a Shipley 1805 positive photoresist material, for example, an optical dispersion may be given by: n=1.59+1.89 E+6/λ²+4.12 E+10/λ⁴. Optical thickness for some light wavelengths are given in Table 1.

TABLE 1
λ/4 Thickness for Shipley 1805 photoresist

| λ (nm) | index (n) | thickness (nm) |
|---|---|---|
| 266 | 1.86 | 35 |
| 325 | 1.77 | 46 |
| 351 | 1.75 | 50 |
| 405 | 1.71 | 59 |
| 532 | 1.66 | 80 |
| 650 | 1.64 | 100 |
| 680 | 1.63 | 104 |

Optics 40 may then be translated in either a continuous manner for a spiral pattern or in discrete steps relative to master 30 so that during a subsequent pass, focused laser spot 42 illuminates a different region of third layer 36. In this way, a plurality of features of master 30 may be photo-etched in third layer 36.

Photo-etching region 44 of third layer 36 defines the PCM for second layer 35. The tip of laser spot 42 and the substantially reflective material of base layer 34 provide fine feature definition for the PCM, which ensures increased resolution of the features of master 30.

FIG. 3B illustrates the portion of master 30 with second layer 35 being etched. The etching process may occur in a reactive ion etching (RIE) system, which may operate substantially similar to etching system 20 from FIG. 2. In the illustrated embodiment, the etching system includes a top electrode 47 that may comprise a positive charge and a bottom electrode 48 that may comprise a negative charge. A current flowing from top electrode 47 to the bottom electrode 48 causes ions 49 to bombard a surface of master 30, which increases a reaction rate of etchant atoms with second layer 35. Etching second layer 35 removes material through photo-etched regions 44 of third layer 36. Second layer 35 is etched through the PCM defined by regions 44 of third layer 36 to define regions 46 in second layer 35. Regions 46 in second layer 35 correspond to features of master 30. In some cases, regions 46 may correspond to tracks of master 30.

Photo-etching regions 44 of third layer 36 via a tip recording process, as described above, creates a substantially sharp third sidewall angle in third layer 36. If the etch process used to etch regions 46 of second layer 35 comprises a selectivity greater than one, second layer 35 may comprise a second sidewall angle greater than the third sidewall angle such that the features of master 30 comprise substantially vertical sidewalls. RIE often increases anisotropy of the etch process. Therefore, the photo-etching and etching processes described herein improve resolution of the features on master 30. The tip recording exposes very fine feature dimensions to the etching process by defining a PCM, and the etching process can be adapted to create a desired wall angle in the second layer for the fine features exposed by the PCM.

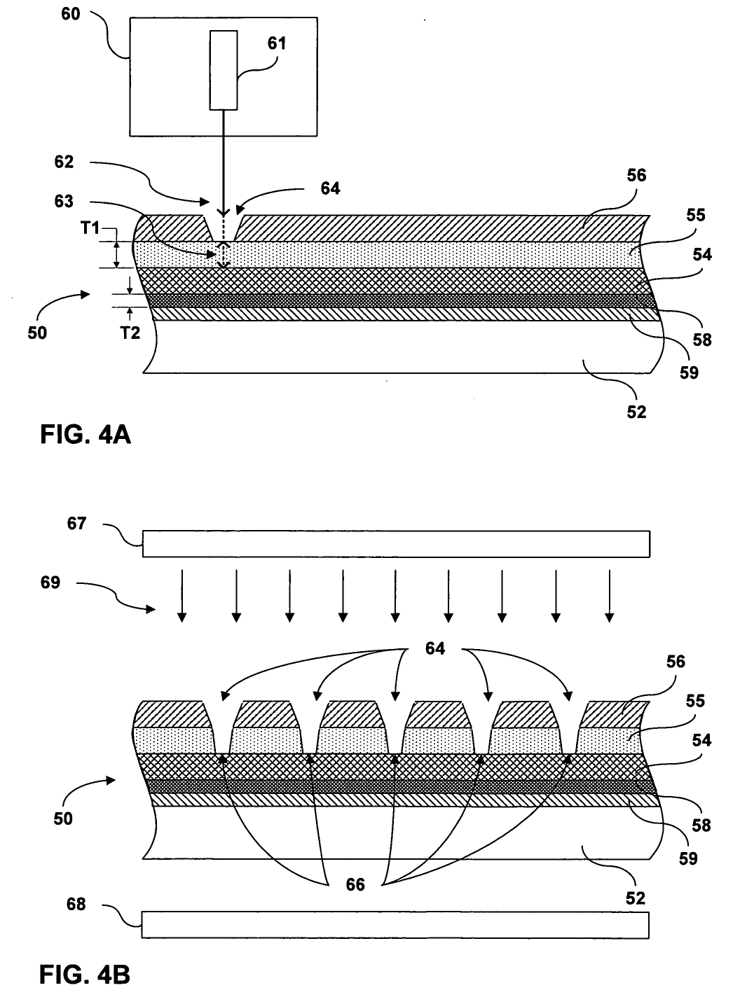

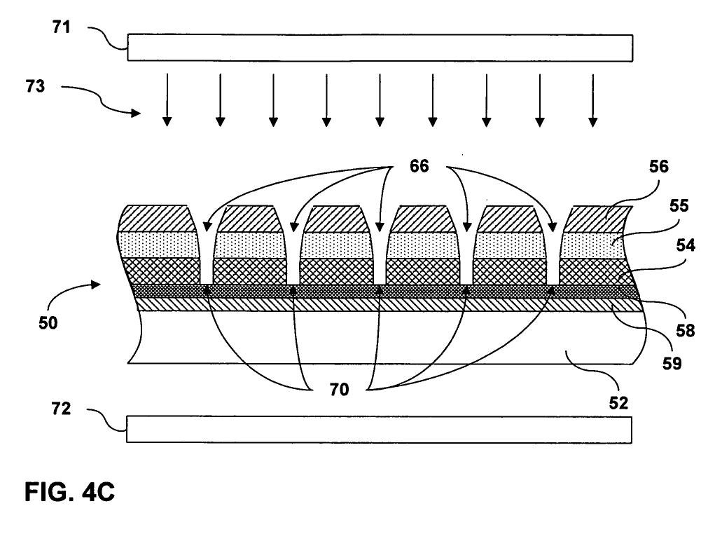

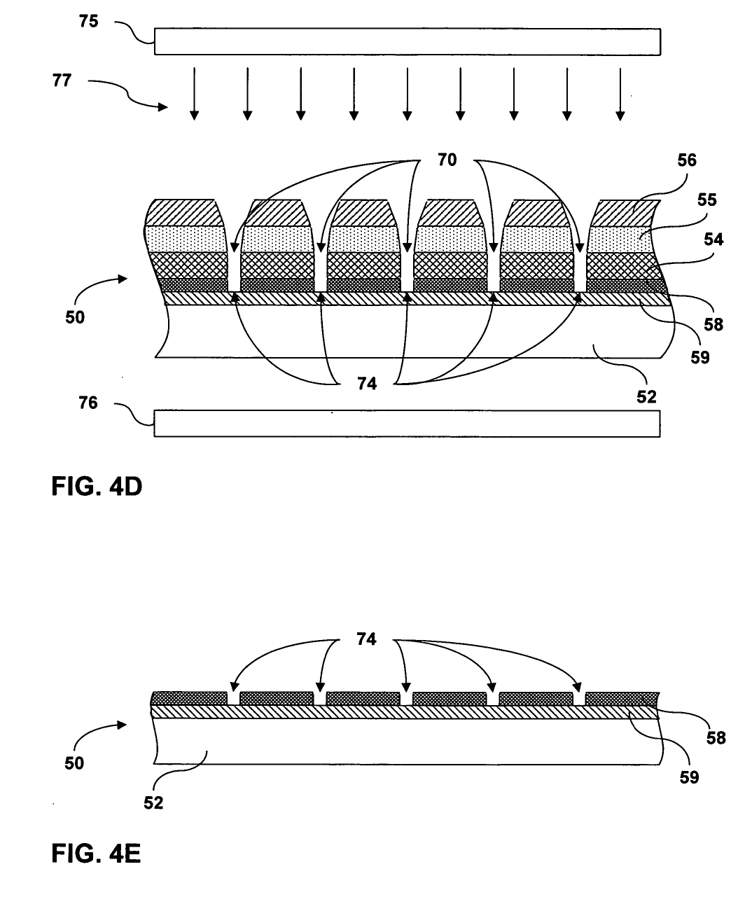

FIGS. 4A-4E are schematic diagrams illustrating a mastering technique for a master 50. Master 50 includes a substrate layer 52 and a multi-layer structure deposited adjacent substrate layer 52. The multi-layer structure comprises a first layer 54, a second layer 55 formed over first layer 54, and a third layer 56 formed over second layer 55. First layer 54 comprises a substantially reflective base layer and second layer 55 comprises an etchable layer. In the illustrated embodiment, second layer 55 comprises a thickness T1 that can be tuned to substantially eliminate stray light from being reflected out of third layer 56. However, in some embodiments, a desired final feature depth of master 50 is not substantially equal to the thickness T1 required for constructive optical interference to effectively couple substantially all of the incident light into the third layer 56. Therefore, another base layer 59 and another etchable layer 58, with a thickness T2 substantially equal to a desired final featured depth, may be interposed between substrate layer 52 and the multi-layer structure to allow flexibility in creating master 50.

In the illustrated embodiment, first layer 54 comprises a substantially reflective base layer that reflects a substantial portion of the light back to third layer 56. The other base layer 59 acts as an etch stop layer. Third layer 56 may comprise a metallic material or another material capable of being photo-etched to define a portable conformable mask (PCM) for second layer 55. In other embodiments, third layer 56 may comprise a phase-change material that can be either ablated or both illuminated and developed in separate steps to define the PCM. In still other embodiments, both second layer 55 and the other etchable layer 58 comprise a dielectric material that may be etched by an etching process. In still other embodiments, first etch layer 55 and/or second etch layer 58 may comprise a photoresist material that can be etched by separate illumination and development steps or by an oxygen plasma process which selectively removes the resist. Again, however, if two or more layers comprise photoresist, the photoresist of the two or more different layers may be sensitive to different wavelengths of light so that a first illumination and development step does not compromise a layer to be later illuminated and developed.

The illustrated techniques include defining a PCM for second layer 55 by photo-etching a region of third layer 56 and separately etching second layer 55 and first layer 54 through the PCM defined by third layer 56. The techniques also include defining a feature of master 50 by etching the other etchable layer 58 through the PCM and the etched regions of second layer 55 and first layer 54. Master 50 may then be used to create stampers and replica disks for optical recording systems.

In other embodiments, two additional layers may not be interposed between the multi-layer structure and the substrate layer. Instead, the second layer in the multi-layer structure may comprise two layers of different material such that the two layers together provide the optical interference function for the master recording step, but remain distinct during the subsequent etching processes due to differences in etch rates. In this way the thickness of the etchable portion of the dual second layer may comprise a thickness equal to a desired feature depth.

FIG. 4A illustrates a portion of master 50 being illuminated by optics 60, which may operate substantially similar to optics 18 in FIG. 1. Optics 60 includes a laser 61 that produces a light. Optics 60 then create a precisely focused laser spot 62 from the light and illuminates third layer 56 of master 50 with focused laser spot 62. Illuminating third layer 56 with laser spot 62 provides energy to photo-etch a region 64 of third layer 56.

As third layer 56 is illuminated, a portion 63 of the light may be transmitted through second layer 55 to first layer 54. However, first layer 54 comprises a substantially reflective base layer that reflects the incident light back to region 64 of third layer 56. Second layer 55 comprises a thickness T1 that can be tuned as an optical interference layer to substantially eliminate reflectivity from the multi-layer construction. For example, the optical thickness of T1 may be approximately equal to a quarter of a wavelength of the incident light. Therefore, the tuned multi-layer structure deposits approximately all of the light from laser spot 62 at region 64 of third layer 56 by constructive interference. In this way, the multi-layer structure increases the efficiency and the accuracy of the photo-etching process used to define the features in the PCM.

As indicated above, thickness T1 associated with second layer 55 may be approximately equal to a quarter of a wavelength of the light. However, the optical λ/4 thickness also takes into account the refractive index of second layer 55 for a given light wavelength. Example optical thicknesses for some light wavelengths are given in Table 1 above.

Optics 60 may then be translated in either a continuous manner for a spiral pattern or in discrete steps relative to master 50 so that during a subsequent pass, focused laser spot 62 illuminates a different region of third layer 56. In this way, a plurality of features of master 50 may be photo-etched in third layer 56.

Photo-etching region 64 of third layer 56 defines the PCM for second layer 55. The tip of laser spot 62 and the optical interference structure of second layer 55 provide fine feature definition for the PCM by effectively coupling the incident laser energy into the PCM layer during master recording. This enables increased resolution of the features of master 50.

FIG. 4B illustrates the portion of master 50 with second layer 55 being etched. The etching process may occur in a reactive ion etching (RIE) system, which may operate substantially similar to etching system 20 from FIG. 2. In the illustrated embodiment, the etching system includes a top electrode 67 that may comprise a positive charge and a bottom electrode 68 that may comprise a negative charge. A current flowing from top electrode 67 to bottom electrode 68 causes ions 69 to bombard a surface of master 50, which increases a reaction rate of etchant atoms with second layer 55. Etching second layer 55 removes material through photo-etched regions 64 of third layer 56. Second layer 55 is etched through the PCM defined by regions 64 of third layer 56 to define regions 66 in second layer 55. Regions 66 in second layer 55 may correspond to features of master 50.

Photo-etching regions 64 of third layer 56 via a tip recording process, as described above, creates a substantially sharp third sidewall angle in third layer 56. If the etch process used to etch regions 66 of second layer 55 comprises a selectivity greater than one, second layer 55 may comprise a second sidewall angle greater than the third sidewall angle such that regions 66 comprise substantially vertical sidewalls. Therefore, the photo-etching and etching processes described herein may improve resolution of the features on master 50.

FIG. 4C illustrates the portion of master 50 with first layer 54 being etched. The etching process may occur in a reactive ion etching (RIE) system, which may operate substantially similar to etching system 20 from FIG. 2. Second layer 55 and first layer 54 may comprise substantially different materials and the etching processes may produce substantially different reactions with the materials such that first layer 54 is not affected during the etching processes of second layer 55 described above. In other words, first layer 54 acts as an etch stop layer for second layer 55.

In the illustrated embodiment, the etching system includes a top electrode 71 that may comprise a positive charge and a bottom electrode 72 that may comprise a negative charge. A current flowing from top electrode 71 to bottom electrode 72 causes ions 73 to bombard a surface of master 50, which increases a reaction rate of etchant atoms with first layer 54. Etching first layer 54 removes material through etched regions 66 of second layer 55. First layer 54 is etched through the PCM defined by third layer 56 and regions 66 of second layer 55 to define regions 70 in first layer 54. Regions 70 in first layer 54 may correspond to features of master 50.

As described above, regions 66 may comprise substantially vertical sidewalls. If the etch process used to etch regions 70 of first layer 54 comprises a selectivity greater than one, first layer 54 may comprise a first sidewall angle greater than the second sidewall angle of second layer 55. Therefore, the etching process described herein may further improve resolution of the features on master 50.

FIG. 4D illustrates the portion of master 50 with the other etchable layer 58 being etched. The etching process may occur in a reactive ion etching (RIE) system, which may operate substantially similar to etching system 20 from FIG. 2. Other etchable layer 58 and first layer 54 may comprise substantially different materials and the etching processes may produce substantially different reactions with the materials such that other etchable layer 58 is not affected during the etching processes of first layer 54 described above. In some cases, other etchable layer 58 may comprise a material substantially similar to second layer 55. First layer 54 may then block the etching processes of second layer 55 from affecting other etchable layer 58.

In the illustrated embodiment, the etching system includes a top electrode 75 that may comprise a positive charge and a bottom electrode 76 that may comprise a negative charge. A current flowing from top electrode 75 to bottom electrode 76 causes ions 77 to bombard a surface of master 50, which increases a reaction rate of etchant atoms with other etchable layer 58. Etching other etchable layer 58 removes material through etched regions 70 of first layer 54. Other etchable layer 58 is etched through the PCM defined by third layer 56, regions 66 of second layer 55, and regions 70 of first layer 54 to define regions 74 in other etchable layer 58. Regions 74 in other etchable layer 58 correspond to features of master 50. In some cases, regions 74 may correspond to tracks of master 50.

As described above, regions 70 may comprise substantially vertical sidewalls. If the etch process used to etch regions 74 of other etchable layer 58 comprises a selectivity greater than one, other etchable layer 58 may comprise a sidewall angle greater than the first sidewall angle of first layer 54. Therefore, the etching process described herein further improves resolution of the features on master 50.

FIG. 4E illustrates the portion of master 50 with third layer 56, second layer 55, and first layer 54 removed. In the illustrated embodiment, master 50 is defined by substrate layer 52, other base layer 59, which acts as an etch stop layer, and other etchable layer 58. Regions 74 in other etchable layer 58 define high resolution features of master 50 with a flexible desired final feature depth.

In other embodiments, either third layer 56, or both third layer 56 and second layer 55 are removed after defining features 74 in other etchable layer 58. Master 50 may be ultimately defined by master substrate 52 and any number of the layers formed over the master substrate. In other words, after photo-etching and etching, all of the layers may remain on master 50, or alternatively one or more of the layers may be removed, with only the remaining layers defining the master features.

The techniques described above may also be used to create masters for the replication of non-optical media, such as magnetic media, that includes topographical surface variations on a nano-scale. For example, the PCM may allow definition of microscopic surface variations in the form of bumps, pits, ridges, grooves, or the like, in the first layer. The master may create a replica disk that includes the nanometer scale topographical features for a magnetic recording system.

Patterned magnetic storage disks may be similarly developed from the master to increase storage densities and improve quality and reliability of magnetic media. The surface of a patterned magnetic medium may be coated with one or more magnetic layers. The surface variations may then be magnetically encoded, e.g., for the purpose of information storage. Each of the nanometer scale topographical features may correspond to a single magnetic domain, although the invention is not necessarily limited in that respect. Within the magnetic recording system, temperature or pressure sensitive transducers responsive to local aerodynamic boundary conditions of the media can detect the surface topology features.

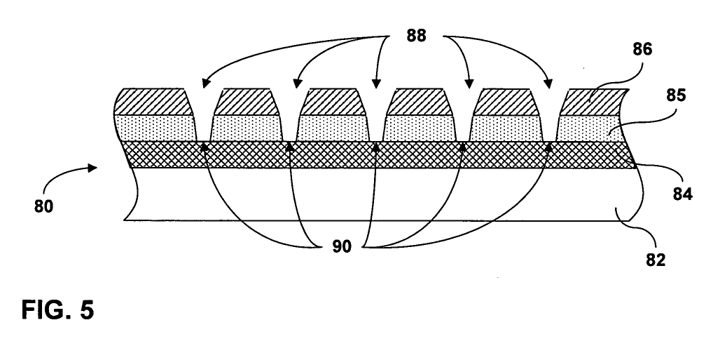

FIG. 5 is a schematic diagram illustrating a portion of a master 80 that may be used to define nanometer scale topographical features. Master 80 includes a substrate layer 82 and a multi-layer structure comprising a first layer 84, a second layer 85 formed over first layer 84, and a third layer 86 formed over second layer 85. In the illustrated embodiment, first layer 84 comprises a substantially reflective base layer designed to reflect light back into third layer 86 during master recording step. First layer 84 also acts as an etch stop layer during a subsequent etching process. For example, first layer 84 may comprise Ni or Al/Cr. It may be assumed that third layer 86 comprises a metallic material, such as Ni, Te, or Ti, or another material capable of being photo-etched to define a PCM for second layer 85. In other embodiments, third layer 86 may comprise a phase-change material, such as GeSbTe (GST) or AgInSbTe (AIST), that can be illuminated and developed in separate steps to define the PCM. Second layer 85 may comprise a dielectric material, such as SiO₂, or another suitably etchable material. In other embodiments, second layer 85 may comprise a photoresist material that can be etched by separate illumination and development steps.

In the illustrated embodiment, regions 88 of third layer 86 have been photo-etched with a light to define a PCM for second layer 85. The photo-etching processes may be substantially similar to the process described in reference to FIG. 3A. Second layer 85 has been etched through regions 88 of the PCM to define regions 90 in second layer 85. The etch process may be substantially similar to the etching process described in reference to FIG. 3B. Regions 90 may correspond to features of master 80. Regions 90 in second layer 85 physically expose regions of first layer 84.

Photo-etching third layer 86 via a tip recording process and etching second layer 85 via RIE, as described above, provides substantially vertical sidewalls at regions 88 and regions 90 respectively. The photo-etching and etching processes described herein may provide a resolution capable of defining lateral dimensions for nanometer scale topographical features on master 80. Therefore, nanometer scale topographical features may be defined at the physically exposed regions of first layer 84.

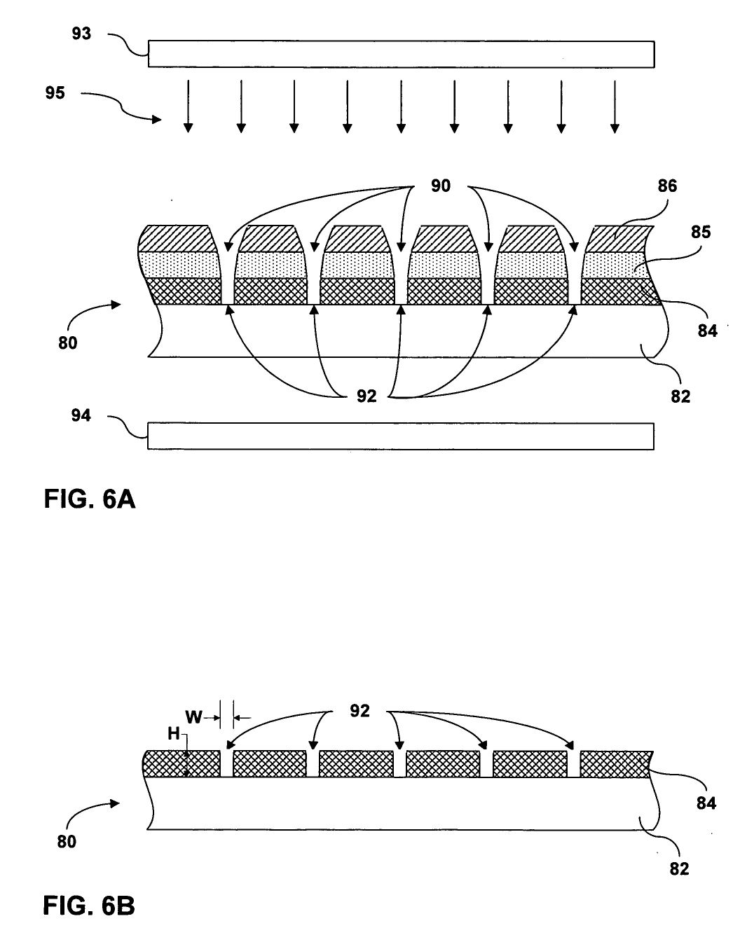

FIGS. 6A and 6B are schematic diagrams illustrating a technique for defining nanometer scale topographical features on a master. FIG. 6A illustrates the portion of master 80 from FIG. 5 with first layer 84 being etched. The etching process may occur in a reactive ion etching (RIE) system, which may operate substantially similar to etching system 20 from FIG. 2. In the illustrated embodiment, the etching system includes a top electrode 93 that may comprise a positive charge and a bottom electrode 94 that may comprise a negative charge. A current flowing from top electrode 93 to bottom electrode 94 causes ions 95 to bombard a surface of master 80, which increases a reaction rate of etchant atoms with first layer 84. First layer 84 is etched through the PCM defined by third layer 86 and regions 90 of second layer 85 to define nanometer scale pits 92 in first layer 84. Pits 92 in first layer 84 correspond to nanometer scale topographical features of master 80. In the invention described herein, the use of the tip recorded PCM defined by third layer 86 and the RIE etch process for second layer 85 defines small openings to first layer 84. In this way, a width of features of master 80 are limited by the sizes of regions 90 in second layer 85, which have been demonstrated to less then 100 nm. The small openings, regions 90, allow etching techniques to control a height of pits 92.

FIG. 6B illustrates the portion of master 80 with third layer 86 and second layer 85 removed. In the illustrated embodiment, master 80 is defined by substrate layer 82 and first layer 84. Pits 92 in first layer 84 define topographical features on the nano-scale. Nanometer scale pits 92 may comprise a height H between approximately 5 and 200 nanometers, and a width W between approximately 20 and 300 nanometers. Master 80 may then be used to create stampers and replica disks for magnetic or other non-optical recording systems. Nanometer scale pits having heights less than 50 nanometers and widths less than 150 nanometers may be difficult or impossible to create with accuracy, without the benefit of the teaching of this disclosure. For nanometer scale pits, the height H may actually refer to a depth of the pits, but is referred to herein as a height H, for consistency in this disclosure.

In other embodiments, only third layer 86 is removed after defining nanometer scale topographical features 92 in first layer 84. Master 80 may be ultimately defined by master substrate 82 and any number of the layers formed over the master substrate. In other words, after photo-etching and etching, all of the layers may remain on master 80, or alternatively one or more of the layers may be removed, with only the remaining layers defining the nanometer scale topographical features.

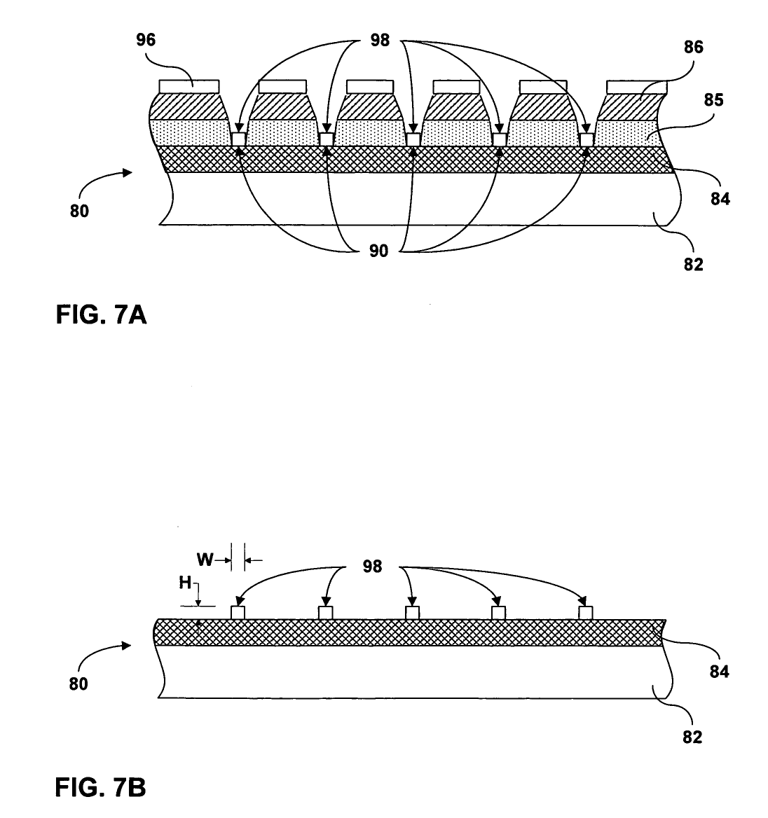

FIGS. 7A and 7B are schematic diagrams illustrating another exemplary embodiment of defining nanometer scale topographical features on a master. In this case, however, material is subsequently deposited over a photo-etched and etched master to define nano-scale topographical bumps. FIG. 7A illustrates the portion of master 80 from FIG. 5 with a thin film material 96 coating master 80. Master 80 may be coated by vacuum depositing thin film material 96 onto master 80. In other embodiments, master 80 may be coated by electroplating thin film material 96 onto master 80.

Coating master 80 with thin film material 96 causes a portion of thin film material 96 to fill etched regions 90 in second layer 84. Thin film material 96 adheres to physically exposed regions of first layer 84 through the PCM defined by third layer 86 and regions 90 of second layer 85. The portion of thin film material 96 that adheres to first layer 84 defines nanometer scale bumps 98 of master 80 on first layer 84. Bumps 98 on first layer 84 correspond to nanometer scale topographical features of master 80.

In conventional spin-coating processes, the solvent photoresist coatings have depth controllable to approximately +/−1-2% for a standard coating thickness of between 50 nanometers and 120 nanometers. However, controlling the depth of the photoresist coatings becomes more difficult for thin coating layers of between 1 nm and 50 nm. In the invention described herein, the use of the tip recorded PCM defined by third layer 86 and the RIE etch process for second layer 85 defines small openings to first layer 84. In this way, a width of topographical features of master 80 are limited by the sizes of regions 90 in second layer 85, which have been demonstrated to less then 100 nm. The small openings, regions 90, allow thin film deposition to control a height of bumps 98. The coating of thin film material 96 has a height controllable to approximately +/−2% for a coating thickness down to a monoatomic thickness.

FIG. 7B illustrates the portion of master 80 with third layer 86 and second layer 85 removed. In the illustrated embodiment, master 80 is defined by substrate layer 82 and first layer 84. Bumps 98 on first layer 84 define topographical features on the nano-scale. Nanometer scale bumps 98 may comprise a height H between approximately 1 and 50 nm, and a width W between approximately 20 and 300 nm. Master 80 may then be used to create stampers and replica disks for magnetic or other non-optical recording systems. Nanometer scale bumps having heights less than 30 nm and widths less than 150 nm may be difficult or impossible to create with accuracy, without the benefit of the teaching of this disclosure.

In other embodiments, only third layer 86 is removed after defining nanometer scale features 98 in first layer 84. Master 80 may be ultimately defined by master substrate 82 and any number of the layers formed over the master substrate. In other words, after photo-etching and etching, all of the layers may remain on master 80, or alternatively one or more of the layers may be removed, with only the remaining layers defining the nanometer scale master features.

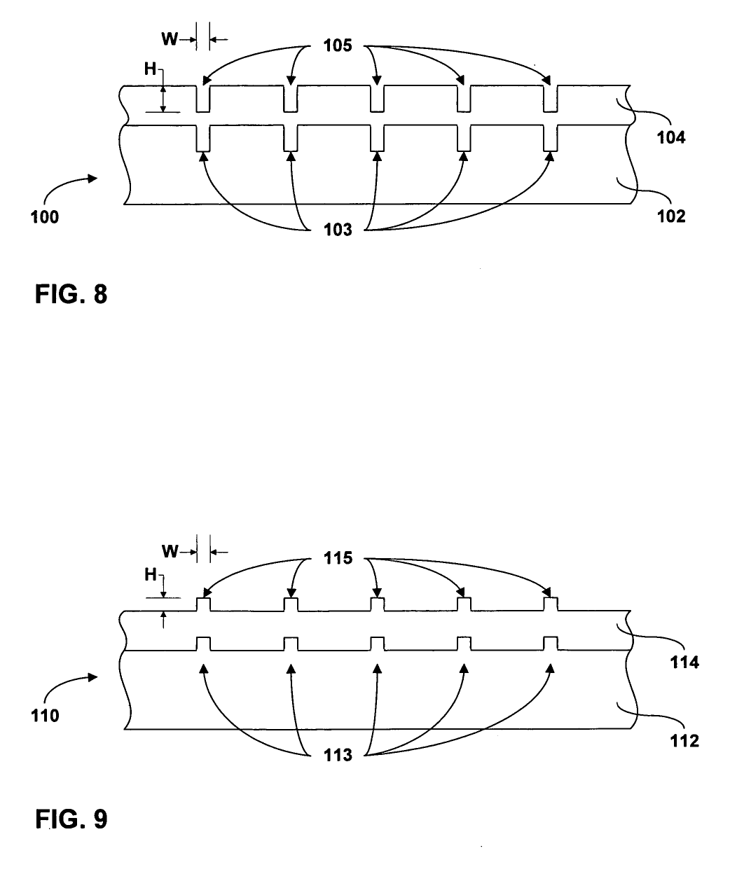

FIG. 8 is schematic diagram illustrating an exemplary data storage disk 100 comprising nanometer scale topographical features 105. Disk 100 may comprise a magnetic storage disk or another non-optical storage disk. In the illustrated embodiment, features 105 comprise nanometer scale pits 105 with a height H between approximately 1 and 100 nm, and a width W between approximately 20 and 300 nm.

In this case, pits 105 are formed by replicating features 103 into a substrate 102. For example, features 103 may be defined during a mastering and stamping process in which a stamper is created from a master and then used in an injection molding process to injection mold substrate 102 to exhibit features 103. Features 103 may be defined during a mastering process substantially similar to the topographical feature mastering process described in FIGS. 6A and 6B.

A substantially continuous magnetic recording layer 104 can be deposited over substrate 102 such that recording layer 104 substantially conforms to features 103. Although illustrated with perfect conformance, magnetic recording layer 104 can be deposited over substrate 102 such that recording layer 104 substantially conforms but does not perfectly conform to features 103. Substantial conformance means that the topographical nature of the features is preserved for readout. Topographical features 105 may then be magnetically encoded, e.g., for the purpose of information storage. Each of nanometer scale pits 105 may be encoded with a single magnetic domain. In this manner, nanometer scale pits 105 can be defined by features 103 formed in substrate 102.

FIG. 9 is a schematic diagram illustrating an exemplary data storage disk 110 comprising nanometer scale topographical features 115. Disk 110 may comprise a magnetic storage disk or another non-optical storage disk. In the illustrated embodiment, features 115 comprise nanometer scale bumps 115 with a height H between approximately 1 and 100 nm, and a width W between approximately 20 and 300 nm.

In this case, bumps 115 are formed by replicating features 113 into a substrate 112. For example, features 113 may be defined during a mastering and stamping process in which a stamper is created from a master and then used in an injection molding process to injection mold substrate 112 to exhibit features 113. Features 113 may be defined during a mastering process substantially similar to the topographical feature mastering process described in FIGS. 7A and 7B.

A substantially continuous magnetic recording layer 114 can be deposited over substrate 112 such that recording layer 114 substantially conforms to features 113. Topographical features 115 may then be magnetically encoded, e.g., for the purpose of information storage. Each of nanometer scale bumps 115 may be encoded with a single magnetic domain. In this manner, nanometer scale bumps 115 can be defined by features 113 formed in substrate 112.

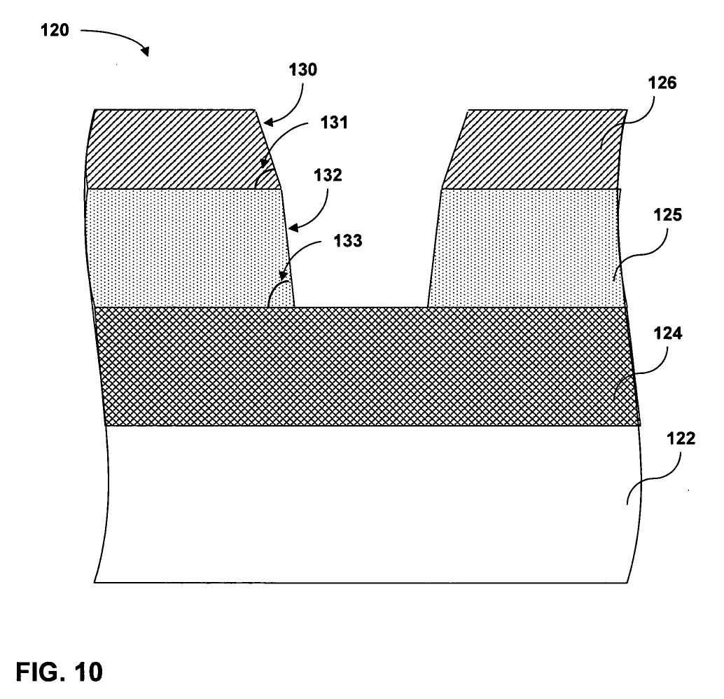

FIG. 10 is a schematic diagram illustrating a trench or groove defined in a master 120 according to an embodiment of the invention. Master 120 includes a substrate layer 122 and a multi-layer structure comprising a first layer 124, a second layer 125 formed over first layer 124, and a third layer 126 formed over second layer 125. Third layer 126 defines a contact mask, i.e., PCM, for second layer 125 to provide high-resolution features in master 120. First layer 124 may comprise a substantially reflective base layer that reflects incident light back into third layer 126. In the illustrated embodiment, second layer 125 comprises a dielectric material capable of being etched and third layer 126 comprises a metallic or other material capable of being photo-etched.

A focused laser spot of light may illuminate a region of third layer 126 in order to photo-etch the region of third layer 126. The photo-etched region defines the PCM in third layer 126. During the photo-etching process, a portion of the light may transmit through second layer 125 to first layer 124. Substantially reflective first layer 124 reflects the light transmitted through second layer 125 back to third layer 126. In addition, second layer 125 may comprise an optical interference thickness that can be tuned to substantially couple all of the incident light into the third layer 126. Therefore, substantially all of the energy from the laser spot is deposited at the region of third layer 126 to form the PCM. The centralized energy improves accuracy and efficiency of the photo-etching process. Photo-etching third layer 126 creates a third layer sidewall 130 comprising a third sidewall angle 131 relative to a horizontal plane.

Master 120 may then be placed in an etching system substantially similar to etching system 20 illustrated in FIG. 2. The etching system may be capable of reactive ion etching (RIE), which is a highly anisotropic process that etches the material of second layer 125 in the vertical direction at a higher rate than in the horizontal direction. Etching second layer 125 creates a second layer sidewall 132 comprising a second sidewall angle 133. Second sidewall angle 133 is based on third sidewall angle 131.

The RIE process comprises a selectivity defined by a ratio between an etch rate of second layer 125 and an etch rate of third layer 126. If third layer 126 and the etching process comprise a selectivity greater than 1 with second layer 125, second layer 125 will be etched faster than third layer 126. In that way, third layer sidewall 130 will be maintained during the etching process. In addition, an increase in third sidewall angle 131, i.e., a more accurate tip recording photo-etching process, will cause an increase in second sidewall angle 133. Also, for a particular third sidewall angle 131, an increase in the selectivity causes an increase in second sidewall angle 133. As shown in FIG. 10, second sidewall angle 133 will be greater than third sidewall angle 131 for a selectivity greater than 1, which increases the feature resolution on master 120. In this way, master 120 may comprise features with substantially vertical sidewalls.

Second sidewall angle 133 of features formed in second layer 125 is dictated by a Gaussian convolution with second layer 125 and by the selectivity of second layer 125 and third layer 126 for a specific etching process. Table 2 lists resulting second sidewall angles 133 of second layer 125 for an etching process with a given selectivity and a given third sidewall angle 131 of third layer 126.

TABLE 2

| Third Sidewall Angle | Etch Selectivity (Second/Third) | | | | |
|---|---|---|---|---|---|
| degrees | 2:1 | 3:1 | 4:1 | 5:1 | 6:1 |
| 30 | 49 | 60 | 67 | 71 | 74 |
| 40 | 59 | 68 | 73 | 77 | 79 |
| 50 | 67 | 74 | 78 | 80 | 82 |
| 60 | 74 | 79 | 82 | 83 | 85 |
| 70 | 80 | 83 | 85 | 86 | 87 |

Various embodiments of the invention have been described. For example, a data storage disk mastering technique has been described that includes coating a substrate layer of a master with a multi-layer structure comprising a first layer, a second layer, and a third layer. The third layer defines a portable conformable mask (PCM) with fine feature definition for the second layer. The first layer may comprise a substantially reflective base layer that reflects the light incident on the first layer back into the third layer in constructive interference to enhance sensitivity of the master recording of the PCM defined in the third layer.

Furthermore, the techniques described above may also be used to create masters for the replication on non-optical media, such as magnetic media, that includes topographical surfaces variations on a nano-scale. For example, a data storage disk has been described that comprises nanometer scale topographical features. The data storage disk may be formed from a maser with nanometer scale bumps or pits defined in the first layer according to the methods described herein.

Nevertheless various modifications can be made to the techniques described herein without departing from the spirit and scope of the invention. For example, the third layer is typically described as comprising a metallic material capable of being photo-etched to define the PCM. However, the third layer may comprise a phase-change material that can either be ablated and developed in separate steps to define a contact mask. In addition, the second layer is typically described as comprising a dielectric material capable of being etched to define the features of the master. However, the second layer may comprise a photoresist material capable of being illuminated and developed in separate steps to define a feature of the master.

Furthermore, the RIE process described herein provides a highly anisotropic etching process that provides enhanced resolution for the features in the second layer. However, a variety of etching processes may be applied to the second layer. In addition, a variety of photo-etching processes may be applied to the third layer that do not require the first layer to comprise a substantially reflective base layer. These and other embodiments may be within the scope of the following claims.

1. A method of creating a data storage disk master comprising:
depositing a multi-layer structure adjacent a substrate layer of the master, the multi-layer structure including a first layer, a second layer formed over the first layer, and a third layer formed over the second layer, wherein the first layer comprises a substantially reflective base layer;
defining a contact mask with the third layer; and
defining a feature of the master in the second layer through the contact mask of the third layer.

2. The method of claim 1, further comprising illuminating the third layer with a light, wherein the reflective base layer substantially reflects the light transmitted through the second layer back to the third layer.

3. The method of claim 2, wherein illuminating the third layer comprises photo-etching a region of the third layer to define the contact mask.

4. The method of claim 2, wherein illuminating the third layer comprises photo-inducing changes to define a region of the third layer to define the contact mask.

5. The method of claim 1, wherein defining a feature of the master in the second layer comprises etching the second layer through the contact mask.

6. The method of claim 1, wherein defining a feature of the master in the second layer comprises illuminating the second layer through the contact mask to photolithographically define a region of the second layer and developing the region of the second layer.

7. The method of claim 1, further comprising defining a nanometer scale topographical feature on the first layer.

8. The method of claim 1, wherein the second layer comprises an etchable layer, the method further comprising:
interposing another base layer and another etchable layer between the substrate layer and the multi-layer structure, wherein the another etchable layer comprises a thickness approximately equal to a final feature depth of the master;
etching the first layer to physically expose a region of the another etchable layer; and
etching the physically exposed region of the another etchable layer to define the feature of the master in the another etchable layer.

9. A data storage disk master comprising:
a substrate layer; and
a multi-layer structure deposited adjacent the substrate layer, the multi-layer structure including a first layer, a second layer formed over the first layer, and a third layer formed over the second layer, wherein the first layer comprises a substantially reflective base layer, and
wherein the third layer defines a contact mask and the second layer defines a feature of the master defined through the contact mask of the third layer.

10. The master of claim 9, wherein the first layer comprises an etch stop layer.

11. The master of claim 9, wherein the third layer comprises one of a metallic material or a phase-change material.

12. The master of claim 9, wherein the second layer comprises one of a dielectric material, a photoresist material, or a dye material.

13. The master of claim 9, wherein the third layer has been illuminated by a light, and wherein the reflective base layer substantially reflects the light transmitted through the second layer back to the third layer.

14. The master of claim 13, wherein the light comprises a focused laser spot capable of photo-etching a region of the third layer to define the contact mask.

15. The master of claim 13, wherein the second layer comprises an optical interference thickness that substantially eliminates reflection of the light out of the multi-layer structure.

16. The master of claim 15, wherein the optical interference thickness comprises a quarter of a wavelength of the light.

17. A method of creating a data storage disk master comprising:
depositing a multi-layer structure adjacent a substrate layer of the master, the multi-layer structure including a first layer, a second layer formed over the first layer, and a third layer formed over the second layer;
defining a contact mask with the third layer;
removing a region of the second layer through the contact mask to physically expose a region of the first layer; and
defining a nanometer scale topographical feature at the physically exposed region of the first layer.

18. The method of claim 17, further comprising etching the first layer to define the nanometer scale topographical feature in the first layer.

19. The method of claim 17, further comprising:
coating the master with a thin film material; and
removing the third layer and the second layer to define the nanometer scale topographical feature on the first layer.

20. The method of claim 17, wherein the first layer comprises a substantially reflective base layer.
